(19) United States
(12) Patent Application Publication
(10) Pub. No.: US 2025/0054179 A1
(43) Pub. Date: Feb. 13, 2025

(54) INFORMATION PROCESSING APPARATUS AND INFORMATION PROCESSING METHOD

(71) Applicant: CANON KABUSHIKI KAISHA, Tokyo (JP)

(72) Inventor: Shogo SATO, Kanagawa (JP)

(21) Appl. No.: 18/768,070

(22) Filed: Jul. 10, 2024

(30) Foreign Application Priority Data
Aug. 9, 2023 (JP) 2023-129838

(51) Int. Cl. G06T 7/70

(52) U.S. Cl. CPC G06T 7/70; G06T 2207/20044; G06T 2207/30196

(57) ABSTRACT

An information processing apparatus detects a detection target in a first image acquired from a first image-capturing device. The information processing apparatus updates, in a first case, reference information, which is stored in a specific memory, relating to the detection target, based on the first image and a second image acquired from a second image-capturing device and does not update, in a second case, the reference information stored in the specific memory. The information processing apparatus estimates a relative position of the detection target with respect to the first image-capturing device, based on a detection result of the detection target and the reference information stored in the specific memory.

### BACKGROUND OF THE INVENTION

### Field of the Invention

The present invention relates to an information processing apparatus and an information processing method.

### Description of the Related Art

In recent years, research has been conducted on mixed reality (MR) technology in which information in a virtual space is superimposed on an image of a real space in real time and presented to a user. In the mixed reality technology, a composite image in which an image of a virtual space corresponding to the position and orientation of an image-capturing device such as a head mounted display (HMD) is superimposed on the entire region or part of an image of a real space captured by the image-capturing device is displayed.

When the composite image is displayed, by detecting (estimating) the position of a detection target such as an actual hand of the user, it is possible to control the display of a virtual object, based on the position and shape of the hand of the user. In order to implement such detection (estimation) of the position of the detection target, for example, it is preferable that a distance between the image-capturing device of the HMD and the hand be accurately estimated.

Japanese Patent Application Publication No. 2008-123462 describes a technique for continuing tracking by using features detected by a stereo camera even when an object, whose distance has been measured by the stereo camera, deviates from a field of view of the stereo camera and enters a field of view of another single camera.

In U.S. Patent Specification No. 11568601, a system detects a hand, based on a distance image captured by a single distance sensor, and compares a sphere that approximates the joints of the hand with the distance image. The system estimates a distance from the sensor to the joint point of the hand, based on a comparison result and the size of the hand being detected.

In the technique disclosed in Japanese Patent Application Publication No. 2008-123462, each of the stereo camera and the single camera needs to perform detection, which requires a processing time. In the technique disclosed in U.S. Patent Specification No. 11568601, a distance sensor needs to be mounted separately from a commonly-used image-capturing device for capturing a luminance image. Therefore, conventionally, the position of a detection target cannot be estimated with a lighter processing load without using a distance sensor.

### SUMMARY OF THE INVENTION

The present invention provides a technique to enable estimation of the position of a detection target with a lighter processing load without using a distance sensor.

The present invention in its one aspect provides an information processing apparatus including: one or more processors configured to: perform a first detection process for detecting a detection target in a first image acquired from a first image-capturing device; perform an update control process in which, in a first case, reference information, which is stored in a specific memory, relating to the detection target is updated based on the first image and a second image acquired from a second image-capturing device and in which, in a second case, the reference information stored in the specific memory is not updated; and perform an estimation process for estimating a relative position of the detection target with respect to the first image-capturing device, based on a detection result of the detection target in the first detection process and the reference information stored in the specific memory.

The present invention in its one aspect provides an information processing method including: detecting a detection target in a first image acquired from a first image-capturing device; updating, in a first case, reference information, which is stored in a specific memory, relating to the detection target, based on the first image and a second image acquired from a second image-capturing device and not updating, in a second case, the reference information stored in the specific memory; and estimating a relative position of the detection target with respect to the first image-capturing device, based on a detection result of the detection target and the reference information stored in the specific memory.

Further features of the present invention will become apparent from the following description of exemplary embodiments with reference to the attached drawings.

### BRIEF DESCRIPTION OF THE DRAWINGS

FIG. 1 illustrates a hardware configuration of an information processing apparatus according to Embodiment 1;

FIG. 2 illustrates a functional configuration of the information processing apparatus according to Embodiment 1;

FIG. 3 is a flowchart of a hand-position estimation process according to Embodiment 1;

FIG. 4 is a flowchart of a reference information update process according to Embodiment 1;

FIG. 5 illustrates detection of joint points of a hand according to Embodiment 1;

FIG. 6 is a flowchart of a reference information update process according to Embodiment 2; and

FIG. 7 is a flowchart of a hand-position estimation process according to Embodiment 3.

### DESCRIPTION OF THE EMBODIMENTS

Hereinafter, embodiments of the present invention will be described in detail with reference to the accompanying drawings. An example in which a hand is detected as a detection target will be described below. However, the detection target is not limited to the hand and may be a part of the body of the user other than the hand or the entire body. The detection target may be an object other than a human body.

### Embodiment 1

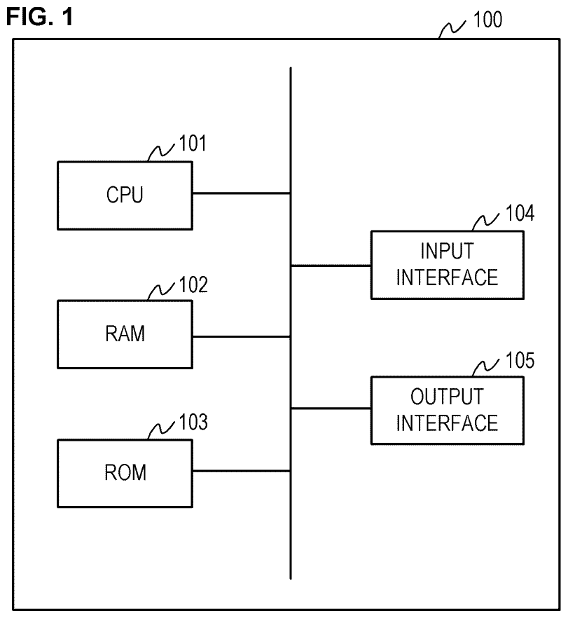

A hardware configuration of an information processing apparatus 100, which is an electronic apparatus, will be described with reference to FIG. 1. The information processing apparatus 100 includes a CPU 101, a RAM 102, a ROM 103, an input interface 104, and an output interface 105.

The CPU 101 controls the entire information processing apparatus 100. The RAM 102 is used as a work area when the CPU 101 performs processing by controlling each unit. The ROM 103 stores a control program, various application programs, data, etc. The CPU 101 loads the control program stored in the ROM 103 into the RAM 102 and executes the loaded control program. This realizes the processing of each unit in the information processing apparatus 100.

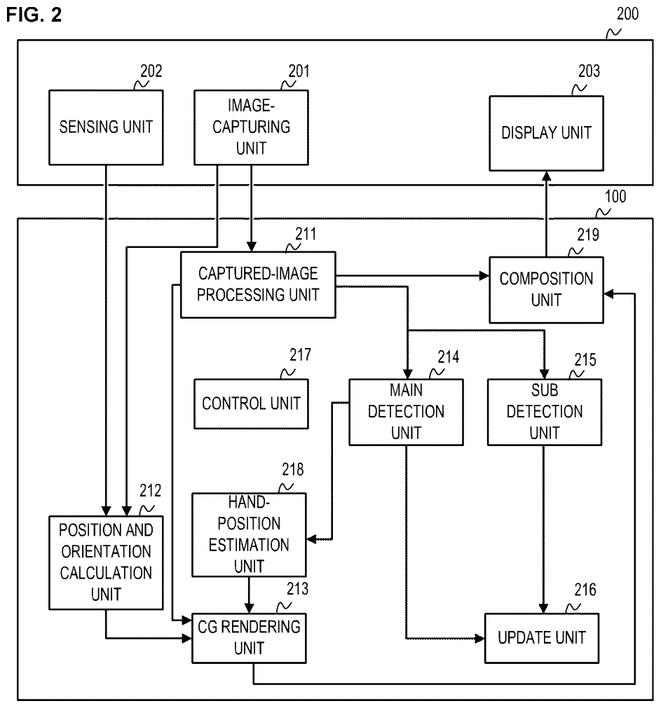

The input interface 104 acquires an input signal in a format that is processable by the information processing apparatus 100 from an HMD 200 (an image-capturing unit 201, a sensing unit 202, or the like) illustrated in FIG. 2. The output interface 105 outputs a display image in a format that is processable by the HMD 200 (a display unit 203).

A functional configuration of the information processing apparatus 100 and the HMD 200 according to Embodiment 1 will be described with reference to FIG. 2. The HMD 200 includes the image-capturing unit 201, the sensing unit 202, and the display unit 203. The information processing apparatus 100 includes a captured-image processing unit 211, a position and orientation calculation unit 212, a CG rendering unit 213, a main detection unit 214, and a sub detection unit 215. The information processing apparatus 100 includes an update unit 216, a control unit 217, a hand-position estimation unit 218, and a composition unit 219.

The image-capturing unit 201 captures an image of a real space (physical world; outside world) by two or more cameras (image-capturing devices). The image-capturing unit 201 includes a stereo camera constituted by “two cameras having at least a part of their field of views overlapped with each other”. Hereinafter, one of the two cameras will be referred to as a “main camera”, and the other will be referred to as a “sub camera”. Which of the two cameras is to be used as the main camera may be determined in advance or may be changed by the setting made by the user.

The sensing unit 202 measures (performs sensing of) inertial information (angular velocities, accelerations, or the like) about the HMD 200. The sensing unit 202 outputs the inertial information obtained by the measurement to the position and orientation calculation unit 212 as sensing information. The sensing unit 202 includes an inertial measurement unit (IMU), an acceleration sensor, an angular velocity sensor, or the like as a sensor. In the present embodiment, the sensing unit 202 is an IMU capable of measuring angular velocities and accelerations of the HMD 200.

The display unit 203 displays a display image generated by the composition unit 219. Thus, the display unit 203 presents the user with an image obtained by combining CG with the image of the real space.

The captured-image processing unit 211 performs image processing on each of an image of the real space captured by the main camera and an image of the real space captured by the sub camera. Hereinafter, an image obtained through the image processing performed on a real-space image captured by the main camera will be referred to as a “main image”, and an image obtained through the image processing performed on a real-space image captured by the sub camera will be referred to as a “sub image”. The image processing performed by the captured-image processing unit 211 may include processing such as demosaicing processing, shading correction, noise reduction, distortion correction, and stereo-parallelization. In the stereo camera, if the object is appropriately detected, a specific point in the real space is captured at the same height in the main image and the sub image by the stereo-parallelization processing.

By converting the real image acquired by the image-capturing unit 201 through the image processing described above, “the content that a human perceives by viewing the image” becomes closer to “the content that a human perceives by directly viewing the object”. Further, the processing in other functional blocks (the position and orientation calculation unit 212, the main detection unit 214, the sub detection unit 215, and the like) can be efficiently performed.

The position and orientation calculation unit 212 calculates the relationship between the world coordinate system (coordinate system in the real space) and the camera coordinate system (coordinate system in the image observed through the HMD 200) based on the main image, the sub image, or the inertial information (information on the acceleration and angular velocity of the HMD 200). Next, the position and orientation calculation unit 212 calculates the position and orientation of the HMD 200 in the world coordinate system based on the calculated relationship.

As a method for calculating the position and orientation, for example, there is a method in which reference markers or the like are placed in a real space, and the position and orientation of the HMD 200 is calculated based on the position of the marker in an image acquired by the image-capturing unit 201. As another method for calculating the position and orientation, for example, there is a method in which the position and orientation of the HMD 200 is calculated by using external sensors or the like that constantly monitor the position of the position and orientation of the HMD 200 in the world coordinate system. In the present embodiment, the method for calculating the position and orientation of the HMD 200 is not particularly limited.

The CG rendering unit 213 reads data of CG from the RAM 102 or the ROM 103. Next, the CG rendering unit 213 calculates the position and orientation of the CG to be used when the CG is superimposed on the main image (or the sub image) based on the information on the position and orientation of the HMD 200. The CG rendering unit 213 renders the CG based on the calculated position and orientation of the CG. For example, the CG rendering unit 213 renders CG reflecting the shape of a hand at the position of the hand.

The main detection unit 214 detects the coordinates (position) of the hand in the main image based on the main image. The main detection unit 214 uses, for example, a detector that is pre-trained using a combination of an image in which a hand is captured and correct coordinates of the hand in the image. The detector detects the coordinates of the hand when receiving the main image as input. Deep Learning (DL) can be used for training the detector. The coordinates of the hand may be coordinates (center coordinates) of a rectangular frame including the hand, coordinates (center coordinates) of the wrist, coordinates of a joint point of the hand, or the like. In the present embodiment, any method may be used as a method in which the main detection unit 214 detects the coordinates of the hand in the main image.

The sub detection unit 215 detects the coordinates (position) of the hand in the sub image based on the sub image by using the same method used by the main detection unit 214.

The update unit 216 calculates (acquires) information (hereinafter, referred to as “reference information”) serving as a reference for obtaining the three-dimensional position of the hand based on the coordinates (detection result) of the hand in the main image and the coordinates (detection result) of the hand in the sub image. The reference information about the hand is, for example, information on the distance (length) between a plurality of joint points in a three-dimensional space, information on a size of the rectangular frame including the hand, information on a size of the hand, or the like. The joint point of the hand is a concept including the joint point of the wrist.

The information processing apparatus 100 uses the initial value of the reference information stored in the storage unit (RAM 102 or ROM 103) until the reference information is calculated. The initial value of the reference information is predetermined. The initial value of the reference information is, for example, information on a statistical size of the hand (a size of the hand of an average adult), information on a size of the hand supplied by the user, information on a size of a rectangular frame obtained from the above information, or the like. When having calculated the reference information as described above, the update unit 216 updates the initial value of the reference information stored in the RAM 102 or the ROM 103 to the calculated reference information.

The update unit 216 calculates the difference between the coordinates of the hand in the main image and the coordinates of the hand in the sub image (in particular, the difference in coordinates in the left-right direction (horizontal direction)). Next, the update unit 216 calculates (acquires) the reference information based on the difference in coordinates and camera parameters. The camera parameters are parameters such as the distance between the main camera and the sub camera and the focal length between the main camera and the sub camera.

In addition, the update unit 216 may calculate the position of the hand in the depth direction (the difference between the position of the hand and the position of the HMD 200 in the depth direction with respect to the image) by stereo matching using the main image and the sub image. Next, the update unit 216 may calculate the distance (the length in the three-dimensional space) between a plurality of joint points as the reference information based on the coordinates of the hand in the main image and the position of the hand in the depth direction. In this case, as the hand is positioned deeper in the depth direction (as the hand is farther from the HMD 200), the hand appears smaller in the main image. Therefore, for example, by multiplying the distance between two joint points in the main image by a coefficient corresponding to the position in the depth direction, the update unit 216 obtains the distance between these two joint points in the three-dimensional space.

In order to increase the accuracy of calculation of the position in the depth direction by stereo matching, infrared light having a wavelength detectable by both the main camera and the sub camera may be projected onto the object. For example, as a method for improving the accuracy by using infrared light, a method in which an object (hand or the like) located at a short distance from the camera is emphasized by irradiating the object with near-infrared light may be used. Further, a method in which an object (for example, a floor or a wall unified in the same color) having no particular feature under visible light is given a feature by irradiating the object with structured infrared light such as random dot patterns may be used.

The control unit 217 controls each unit (for example, determines execution conditions for each unit).

The hand-position estimation unit 218 estimates the relative position of the hand with respect to the HMD 200 (main camera) based on the coordinates of the hand in the main image and the reference information about the hand. The position of the hand estimated by the hand-position estimation unit 218 may be the position of the center (center of gravity) of the hand or may be the positions of a plurality of joint points as long as the position is a three-dimensional position. The hand-position estimation unit 218 may further estimate the orientation of the hand based on the positions of the plurality of joint points.

For example, the hand-position estimation unit 218 can obtain the relative positional relationship of the three joint points with respect to the HMD 200 (main camera) based on the coordinates of each of the three joint points in the main image and the distance (length) between each pair of the three joint points in the three-dimensional space. In this case, the hand-position estimation unit 218 can obtain the relative positional relationship of the three joint points with respect to the HMD 200 (main camera) by solving a perspective-3-point (P3P) problem. The hand-position estimation unit 218 may solve the P3P problem by a direct solution method. The hand-position estimation unit 218 may solve the P3P problem by an indirect solution method in which an optimization calculation is performed by using the positions obtained in the previous frame as initial values. When the P3P problem is solved by the direct solution method, four solutions could be derived at the maximum. In this case, the most likely solution may be selected from the derived real-number solutions based on the inclinations of the three points or the distance from the HMD 200 (main camera), for example. It is preferable that the distance (length) between each pair of the three joint points used for this calculation be unlikely to vary due to a change in shape of the hand.

In addition, in case where the inclination of the hand or the relative positional relationship between the joint points of the hand is obtained by the detector trained by deep learning (DL) or the like in the main detection unit 214, a method using the distance between two joint points may also be considered. By setting an unknown value as the depth of one of the two points, a quadratic equation can be formulated from the geometric positional relationship, and thus, the direct solution method can be used. It is preferable that the length of the two points used for this calculation be unlikely to vary due to a change in shape of the hand.

The composition unit 219 combines the main image (or the sub image) in which a real space is captured with the CG image acquired from the CG rendering unit 213. The composition unit 219 generates a display image through this image composition.

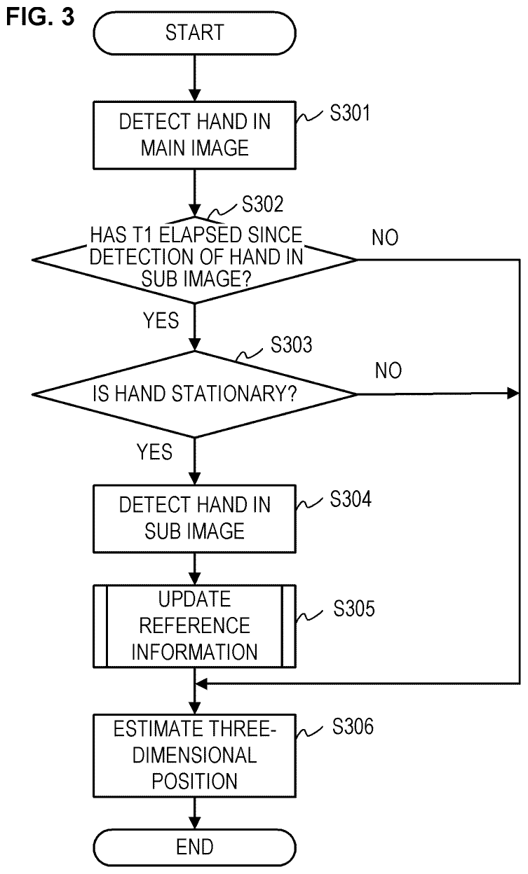

A hand-position estimation process will be described with reference to a flowchart in FIG. 3. The control unit 217 of the information processing apparatus 100 executes a program to perform the process of the flowchart in FIG. 3 for each frame (or at specific time intervals) during activation of the HMD 200. Hereinafter, the process performed on “one hand” of the left and right hands will be described, and this “one hand” will be referred to as a “target hand”.

In step S301, the control unit 217 controls the main detection unit 214 such that the main detection unit 214 detects the “target hand” in the main image and also detects the coordinates of the “target hand” in the main image.

In step S302, the control unit 217 determines whether or not a specific time period T1 has elapsed since the execution of the most recent processing of step S304 (the previous detection of the coordinates of the “target hand” in the sub image). If it is determined that the specific time period T1 has elapsed since the execution of the most recent processing of step S304, the processing proceeds to step S303. If it is determined that the specific time period T1 has not elapsed since the execution of the most recent processing of step S304, the processing proceeds to step S306.

In step S303, the control unit 217 determines whether or not the “target hand” is stationary. Specifically, the control unit 217 determines whether or not the coordinates of the “target hand” in the main image detected by the main detection unit 214 have changed. For example, when a plurality of joint points of the “target hand” have been detected, the control unit 217 obtains the square of the difference between the detected coordinates of the previous frame and the detected coordinates of the current frame as the detection difference for each of the detected joint points. Based on whether or not the mean value of the detection differences of all the detected joint points is equal to or less than a certain value, the control unit 217 can determine whether or not the coordinates of the “target hand” have changed. If it is determined that the coordinates of the “target hand” have not changed (the “target hand” is stationary), the processing proceeds to step S304. If it is determined that the coordinates of the “target hand” have changed (the “target hand” is not stationary), the processing proceeds to step S306.

In step S304, the control unit 217 controls the sub detection unit 215 such that the sub detection unit 215 detects the “target hand” in the sub image and also detects the coordinates of the “target hand” in the sub image.

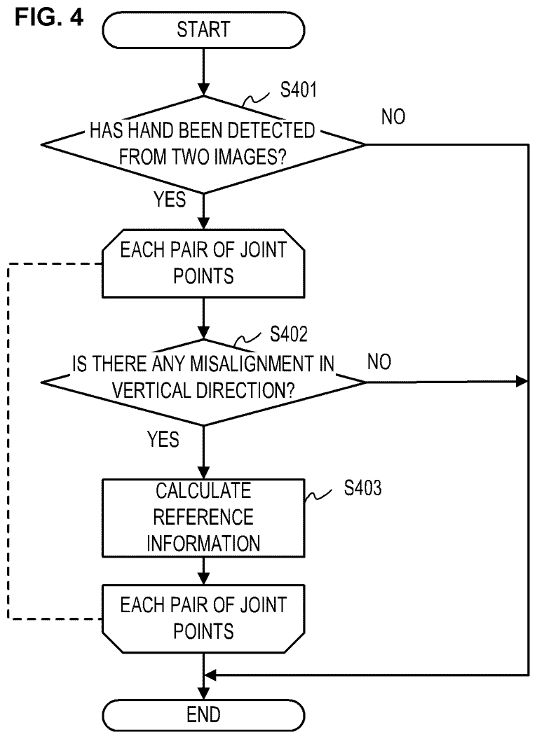

In step S305, the control unit 217 controls the update unit 216 such that the update unit 216 updates the reference information on the “target hand” stored in the RAM 102 or the ROM 103 based on the coordinates of the “target hand” in the main image and the coordinates of the “target hand” in the sub image. The processing in step S305 will be described in detail below with reference to a flowchart in FIG. 4.

In step S306, the control unit 217 controls the hand-position estimation unit 218 such that the hand-position estimation unit 218 estimates the three-dimensional position of the “target hand” based on the information on the coordinates of the “target hand” in the main image and the reference information stored in the RAM 102 or the ROM 103. Specifically, the hand-position estimation unit 218 estimates (acquires) the relative position of the “target hand” with respect to the HMD 200 (main camera).

As described above, in step S302, if it is determined that the specific time period T1 (fixed time period) has not elapsed since the most recent processing of step S304, the processing proceeds to step S306. In step S303, if it is determined that the hand is not stationary, the processing proceeds to step S306. That is, in these cases, since the detection of the coordinates of the “target hand” in the sub image and the update of the reference information are not to be performed, the image-capturing process by the sub camera and the reference information calculation process are not necessary. Therefore, according to the process of the flowchart in FIG. 3, compared to the case where the image-capturing is constantly executed by the stereo camera during the stationary state, the processing load can be reduced, and the processing delay can be reduced.

The flowchart in FIG. 4 illustrates details of the processing in step S305. Hereinafter, an example in which “the length between a plurality of joint points of the hand” is used as “reference information” will be described.

In step S401, the update unit 216 determines whether or not the “target hand” has been detected from both the main image and the sub image. If the “target hand” has been detected from the two images, the processing proceeds to step S402. If the “target hand” has not been detected from at least one of the two images, the process of the present flowchart ends.

In steps S402 and S403, processing is performed based on the position of each joint point in the main image and the sub image. Therefore, in step S401, whether or not the “target hand” has been detected from both the main image and the sub image may be read as whether or not a predetermined number or more of joint points of the “target hand” have been captured. That is, even in case where the “target hand” has been detected in both the main image and the sub image, if the predetermined number or more of joint points of the “target hand” are not captured in both of the two images, the process of the present flowchart may end.

The processing in steps S402 and S403 is performed for each pair of the joint points of the “target hand”. Hereinafter, the two joint points to be processed in steps S402 and S403 will be referred to as a “first joint point” and a “second joint point”.

In step S402, the update unit 216 determines whether or not the difference between the coordinates (detected coordinates) of a first joint point in the vertical direction (perpendicular direction) in the main image and the coordinates (detected coordinates) of the first joint point in the vertical direction in the sub image is equal to or less than a fixed value Th1. The update unit 216 determines whether or not the difference between the coordinates (detected coordinates) of a second joint point in the vertical direction (perpendicular direction) in the main image and the coordinates (detected coordinates) of the second joint point in the vertical direction in the sub image is equal to or less than the fixed value Th1. If the difference between the coordinates in the vertical direction is equal to or less than the fixed value Th1 for both of the two joint points, the processing proceeds to step S403. If the difference between the coordinates in the vertical direction exceeds the fixed value Th1 for at least one of the two joint points, the processing for these two joint points (this pair of joint points) ends, and the processing in step S402 is performed on the next pair of joint points. That is, in this case, “the information on the distance between the first joint point and the second joint point” in the reference information is not updated.

A stereo-parallelization processing has been performed on the main image and the sub image. Therefore, if a certain joint point is correctly detected, the coordinates of this joint point in the vertical direction are supposed to be the same in the main image and the sub image. Thus, when the coordinates of the same joint point in the vertical direction are greatly different between the two images, it is assumed that the error in detections of the joint point is so large that the reference information cannot be updated with sufficient accuracy.

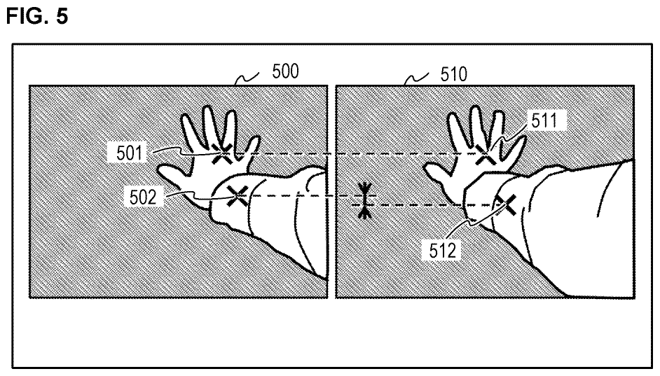

FIG. 5 illustrates an example of detection of joint points of a hand in the main image and the sub image. A right hand is captured in both of a main image 500 and a sub image 510, and a joint point of the base of the middle finger and a joint point of the wrist are detected in each image. A detected position 501 of the joint point of the base of the middle finger in the main image 500 and a detected position 511 of the joint point of the base of the middle finger in the sub image 510 have the same coordinates in the vertical direction. Therefore, it can be said that the coordinate detections performed on the joint point of the base of the middle finger are highly reliable. On the other hand, a detected position 502 of the joint point of the wrist in the main image 500 and a detected position 512 of the joint point of the wrist in the sub image 510 have greatly different coordinates in the vertical direction. Therefore, there is a possibility that the coordinate detections performed on the joint point of the wrist have large errors.

In step S403, the update unit 216 obtains the difference in the coordinates of the first joint point (hereinafter, referred to as a “first difference”) between the main image and the sub image and the difference in the coordinates of the second joint point (hereinafter, referred to as a “second difference”) between the main image and the sub image. The update unit 216 reads the camera parameters of the main camera and the sub camera stored in the ROM 103. Next, the update unit 216 obtains the distance from each camera to the first joint point (hereinafter, referred to as a “first distance”) and the distance from each camera to the second joint point (hereinafter, referred to as a “second distance”) based on the first difference, the second difference, and the camera parameters.

Thereafter, the update unit 216 calculates three-dimensional coordinates (coordinates based on the position and orientation of the HMD 200) of the first joint point and the second joint point based on the first distance, the second distance, and the coordinates of the two joint points (the coordinates of the first joint point and the coordinates of the second joint point) in the main image. The update unit 216 calculates the distance (Euclidean distance) between the first joint point and the second joint point in the real space based on the three-dimensional coordinates of the first joint point and the second joint point. The update unit 216 stores the information on the distance between the first joint point and the second joint point in the RAM 102 or the ROM 103 as one piece of information in the reference information by overwriting the existing one. That is, the update unit 216 updates the “information on the distance between the first joint point and the second joint point” in the reference information to the newly calculated “information on the distance between the first joint point and the second joint point”.

According to Embodiment 1, the position of the hand, which is the detection target, can be estimated without using a distance sensor. In addition, since it is possible to estimate the position of the hand without using a camera other than the stereo camera, the information processing apparatus can estimate the position of the hand with a light processing load. Furthermore, since the update (acquisition) of the reference information is performed less frequently than the estimation of the position of the hand, the processing load placed on the information processing apparatus by using the sub image can also be reduced.

### Modification 1

In Embodiment 1, the process for estimating the position of one of the left and right hands has been described. However, when two (left and right) hands are captured in the main image and the sub image, the flowcharts in FIGS. 3 and 4 may be executed for each of the two hands.

### Embodiment 2

In Embodiment 1, the information processing apparatus 100 updates the reference information about the hand stored in the RAM 102 or the ROM 103 each time the reference information about the hand is calculated (acquired). In this case, when an error occurs in the detection result of the coordinates of the hand in the main image or the sub image, an error also occurs in the reference information, and further, an error could occur in the estimation of the position of the hand.

Therefore, in Embodiment 2, the information processing apparatus 100 reduces the impact of a detection error on the reference information and the estimation of the position of the hand by using the mean of the distances between two joint points obtained in a plurality of frames, for example.

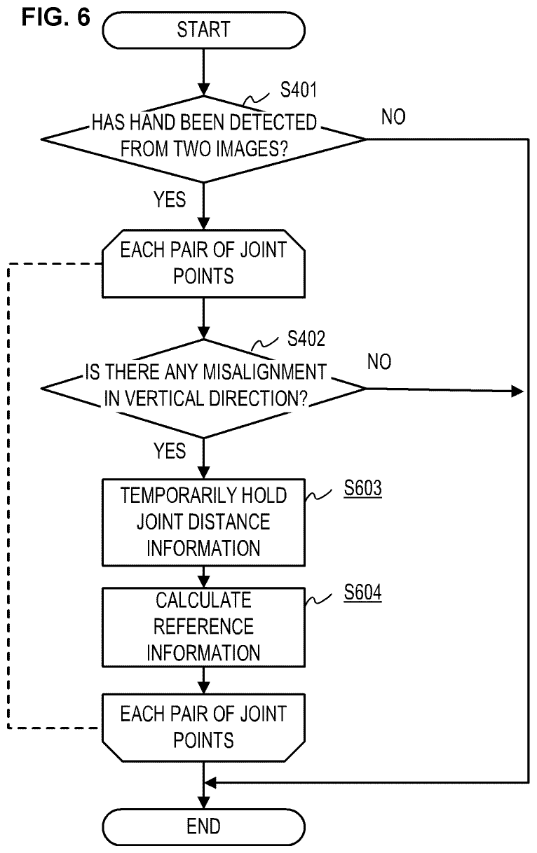

A flowchart in FIG. 6 illustrates processing in step S305 according to Embodiment 2 to be performed instead of the processing in the flowchart in FIG. 4. In the present embodiment, an example in which the length between the joint points is used as the reference information will be described.

Processing in steps S401 and S402 is the same as the processing in steps S401 and S402 according to Embodiment 1. Processing in steps S402, S603, and S604 is performed for each pair of the joint points of the “target hand” as in Embodiment 1. The two joint points to be processed in steps S402, S603, and S604 will be referred to as a “first joint point” and a “second joint point”.

In step S603, the update unit 216 calculates information on the distance between the first joint point and the second joint point as “joint distance information” by the same method as in step S403 according to Embodiment 1. Next, the update unit 216 adds the joint distance information (information on the distance between the first joint point and the second joint point) to a reference information queue. The reference information queue has a data structure capable of storing the calculated joint distance information for each pair of joint points a plurality of times (a predetermined number of times). The reference information queue is stored in the RAM 102 or the ROM 103. In case where more pieces of joint distance information than the predetermined number of times (predetermined number of frames) are stored in the reference information queue, the update unit 216 deletes the oldest piece of joint distance information from the reference information queue.

In step S604, the update unit 216 obtains a mean value of a plurality of pieces of joint distance information registered in the reference information queue. Next, the update unit 216 updates the information on the distance between the first joint point and the second joint point in the reference information stored in the storage unit (the RAM 102 or the ROM 103) to the mean value of the plurality of pieces of joint distance information.

According to Embodiment 2, by using the mean value of the plurality of pieces of joint distance information, variations due to measurement errors can be stabilized, and the accuracy of estimation of the position of the hand can be stabilized.

### Embodiment 3

In Embodiment 3, the information processing apparatus 100 minimizes the load by updating the reference information only when the user wearing the HMD 200 is changed.

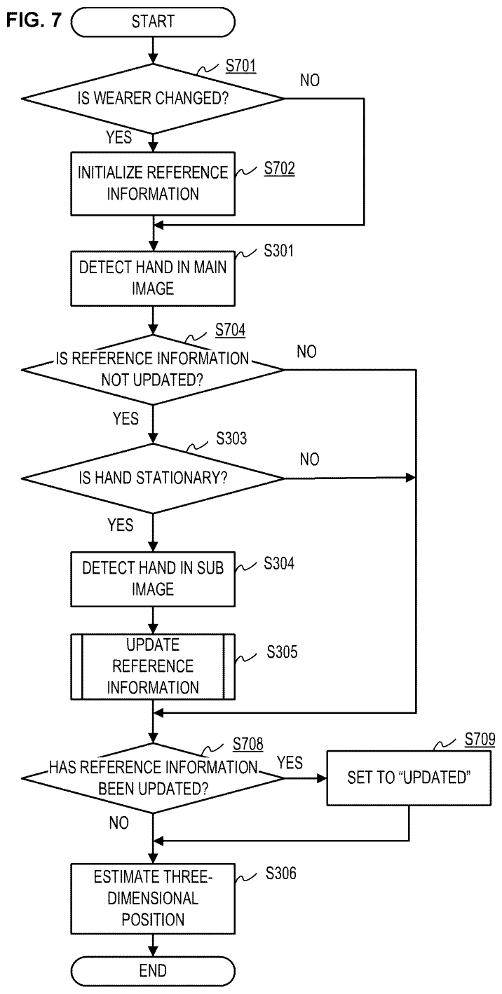

A hand-position estimation process according to Embodiment 3 will be described with reference to a flowchart in FIG. 7. The control unit 217 of the information processing apparatus 100 performs this process for each frame during activation of the HMD 200. Since the processing in steps S301 and S303 to S306 in FIG. 7 is the same as the processing in steps S301 and S303 to S306 in FIG. 3, detailed description thereof will be omitted.

In step S701, the control unit 217 determines whether or not the user (wearer) wearing the HMD 200 has been changed. If it is determined that the wearer of the HMD 200 has been changed, the processing proceeds to step S702. If it is determined that the wearer of the HMD 200 has not been changed, the processing proceeds to step S301.

For example, when an object-detecting mode of a proximity sensor mounted on the HMD 200 is switched from a non-proximity mode to a proximity mode, the control unit 217 detects that the wearer of the HMD 200 has been changed. Alternatively, the control unit 217 identifies a person through iris recognition using a camera mounted on the HMD 200 for capturing an image of the pupils of the wearer. In this way, the control unit 217 may detect a change of the wearer of the HMD 200.

In step S702, the control unit 217 controls the update unit 216 such that the update unit 216 sets the state of the reference information to a non-updated state and updates (rewrites) the reference information stored in the RAM 102 or the ROM 103 to the initial value.

In step S704, the control unit 217 determines whether or not the reference information is in the non-updated state. If it is determined that the reference information is in the non-updated state, the processing proceeds to step S303. If it is determined that the reference information is in the updated state, the processing proceeds to step S708.

In step S708, the control unit 217 determines whether or not the update unit 216 has updated the reference information in step S305. If it is determined that the reference information has been updated, the processing proceeds to step S709. If it is determined that the reference information has not been updated, the processing proceeds to step S306.

In step S709, the control unit 217 sets the state of the reference information to “updated” and stores the information on the state of the reference information in the RAM 102.

According to Embodiment 3, the information processing apparatus 100 updates the reference information only when the wearer of the HMD 200 is changed. This can reduce the processing load of the information processing apparatus 100.

According to the present invention, the position of the detection target can be estimated with a lighter processing load without using a distance sensor.

The present invention has thus been described based on the preferred embodiments. However, the present invention is not limited to these specific embodiments, and various modes within the scope not departing from the gist of the present invention are also included in the present invention. Some parts of the above-described embodiments may be combined as appropriate.

In the above description, “if A is equal to or more than B, the processing proceeds to step S1, and if A is smaller (lower) than B, the processing proceeds to step S2” may be read as “if A is larger (higher) than B, the processing proceeds to step S1, and if A is equal to or less than B, the processing proceeds to S2”. Conversely, “if A is larger (higher) than B, the processing proceeds to step S1, and if A is equal to or less than B, the processing proceeds to step S2” may be read as “if A is equal to or more than B, the processing proceeds to step S1, and if A is smaller (lower) than B, the processing proceed to step S2”. Thus, unless a contradiction arises, the expression “equal to or more than A” may be read as “larger (higher; longer; more) than A”, and the expression “equal to or less than A” may be read as “smaller (lower; shorter; less) than A”. In addition, the expression “larger (higher; longer; more) than A” may be read as “equal to or more than A”, and the expression “smaller (lower; shorter; less) than A” may be read as “equal to or less than A”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-129838, filed on Aug. 9, 2023, which is hereby incorporated by reference herein in its entirety.

What is claimed is:

1. An information processing apparatus comprising:
one or more processors configured to:
perform a first detection process for detecting a detection target in a first image acquired from a first image-capturing device;
perform an update control process in which, in a first case, reference information, which is stored in a specific memory, relating to the detection target is updated based on the first image and a second image acquired from a second image-capturing device and in which, in a second case, the reference information stored in the specific memory is not updated; and
perform an estimation process for estimating a relative position of the detection target with respect to the first image-capturing device, based on a detection result of the detection target in the first detection process and the reference information stored in the specific memory.

2. The information processing apparatus according to claim 1, wherein
in the first detection process, the first image is newly acquired from the first image-capturing device at fixed time intervals, and the detection target is detected in the acquired first image,
in the update control process, the reference information is updated each time the detection target is detected in the first detection process in the first case, and
in the estimation process, a relative position of the detection target with respect to the first image-capturing device is estimated each time the detection target is detected in the first detection process.

3. The information processing apparatus according to claim 1, wherein
in the first case, a second detection process for detecting the detection target in the second image is further performed.

4. The information processing apparatus according to claim 3, wherein
in the update control process, the reference information is updated in the first case, based on a detection result of the detection target in the first detection process and a detection result of the detection target in the second detection process.

5. The information processing apparatus according to claim 3, wherein
the second case includes a case where a fixed time period has not elapsed since a previous detection of the detection target in the second image in the second detection process.

6. The information processing apparatus according to claim 1, wherein
a first determination process for determining whether or not the detection target is stationary is further performed based on a detection result of the detection target in the first detection process, and
the second case includes a case where it is determined that the detection target is not stationary.

7. The information processing apparatus according to claim 1, wherein
a second determination process for determining whether or not a user using the information processing apparatus is changed is further performed, and
the second case includes a case where it is determined that a user using the information processing apparatus is not changed.

8. The information processing apparatus according to claim 1, wherein
in the update control process, information relating to the detection target is acquired in the first case, based on the first image and the second image, and the reference information is updated to a mean of the information relating to the detection target that has been acquired a plurality of times.

9. The information processing apparatus according to claim 1, wherein
the detection target is a hand.

10. The information processing apparatus according to claim 9, wherein
the detection result of the detection target indicates coordinates of each joint point of the hand, and
the reference information is information on a length between a plurality of joint points.

11. The information processing apparatus according to claim 10, wherein
the reference information includes information on a length between a first joint point and a second joint point,
in the update control process, in a case where at least one of a first difference and a second difference is larger than a fixed value, information on a length between the first joint point and the second joint point in the reference information is not updated even in the first case, and
the first difference is a difference between a position of the first joint point in a vertical direction in the first image and a position of the first joint point in a vertical direction in the second image, and
the second difference is a difference between a position of the second joint point in a vertical direction in the first image and a position of the second joint point in a vertical direction in the second image.

12. The information processing apparatus according to claim 1, wherein
in the update control process in the first case,
a position of the detection target in a depth direction with respect to an image is measured based on the first image and the second image, and
the reference information is updated based on the position in the depth direction and a detection result of the detection target in the first detection process.

13. An information processing method comprising:
detecting a detection target in a first image acquired from a first image-capturing device;
updating, in a first case, reference information, which is stored in a specific memory, relating to the detection target, based on the first image and a second image acquired from a second image-capturing device and not updating, in a second case, the reference information stored in the specific memory; and
estimating a relative position of the detection target with respect to the first image-capturing device, based on a detection result of the detection target and the reference information stored in the specific memory.

14. A non-transitory computer readable medium that stores a program, wherein the program causes a computer to execute an information processing method comprising:
detecting a detection target in a first image acquired from a first image-capturing device;
updating, in a first case, reference information, which is stored in a specific memory, relating to the detection target, based on the first image and a second image acquired from a second image-capturing device and not updating, in a second case, the reference information stored in the specific memory; and
estimating a relative position of the detection target with respect to the first image-capturing device, based on a detection result of the detection target and the reference information stored in the specific memory.
